(19) United States
(12) Patent Application Publication
(10) Pub. No.: US 2026/0206758 A1
(43) Pub. Date: Jul. 23, 2026

(54) RESIN COMPOSITION CONTAINING FIPRONIL AND SUSTAINED-RELEASE PEST CONTROL RESIN MOLDED ARTICLE USING THE SAME

(71) Applicant: OSAKA PHARMACEUTICAL CO., LTD., Osaka (JP)

(72) Inventor: Katsushige TOKUNO, Osaka (JP)

(21) Appl. No.: 19/140,764

(22) PCT Filed: Dec. 19, 2023
(86) PCT No.: PCT/JP2023/045498

§ 371 Date: Jun. 18, 2025

(30) Foreign Application Priority Data
Dec. 21, 2022 (JP) 2022-204246

(51) Int. Cl. A01N 43/56; A01N 25/10; A01N 25/34; A01P 7/04

(52) U.S. Cl. CPC A01N 43/56; A01N 25/10; A01N 25/34; A01P 7/04

(57) ABSTRACT

To provide a resin composition suitable for producing a molded article directly applied to animals, and a resin molded article using the same. A pest control resin composition containing fipronil, an insect growth regulator, a plasticizer, a fatty acid, and a vinyl chloride resin is prepared. Such a resin composition may further contain optional components. Here, pests typically include fleas, ticks, mosquitoes, or lice. Such a resin composition can be suitably used for the production of pest control resin molded articles.

### TECHNICAL FIELD

The present invention relates to a resin composition containing fipronil for controlling pests that infest animals such as pets and livestock. More specifically, the present invention relates to a fipronil-containing resin composition and a sustained-release pest control resin molded article using the same, which are excellent in pest control effects for animals and can be used for pet collars and the like.

### BACKGROUND ART

Pests that infest animals closely associated with humans, such as pets or livestock, can transmit diseases that cause serious symptoms in these animals, or can cause allergies or harmful effects in humans. For these pests, pest control agents for dripping, spraying, or applying to the body surface of pets or livestock are generally known.

As active ingredients for such pest control agents, pyrethroid compounds or phenylpyrazole compounds are widely used (Patent Literature 1).

### PRIOR ART DOCUMENTS

### Patent Documents

[Patent document 1]
Japanese Unexamined Patent Publication No. 2019-14673

### SUMMARY OF THE INVENTION

### Problems to be Solved by the Invention

Fipronil, a phenylpyrazole compound, is known as a pest control agent. However, fipronil is solid at room temperature and has not been molded into collars or the like by being incorporated into a resin composition.

The present invention aims to provide a resin composition and a molded article using the same, which have excellent pest control effects on animals to be protected from pests, and have a good balance of appropriate elongation and strength.

### Means for Solving the Problems

As a result of intensive studies to solve the above problems, the present inventors have found that a resin composition excellent in moldability and capable of reliably controlling pests can be prepared by incorporating fipronil, an insect growth regulator, a plasticizer, a fatty acid, and a vinyl chloride resin, thereby completing the present invention.

That is, in one aspect of the present invention, the following resin composition is provided: A pest control resin composition containing a vinyl chloride resin, fipronil, an insect growth regulator, a plasticizer, and a fatty acid.

Furthermore, in another aspect of the present invention, the following molded article is provided: A sustained-release pest control resin molded article formed by molding a pest control resin composition containing a vinyl chloride resin, fipronil, an insect growth regulator, a plasticizer, and a fatty acid.

Furthermore, in another aspect of the present invention, the following method is provided: A method for improving the strength of a resin molded article obtained from a resin composition by coexisting a vinyl chloride resin, fipronil, an insect growth regulator, a plasticizer, and a fatty acid in the composition.

### Effects of the Invention

The present invention can provide an excellent resin composition that can be molded into collars and the like, which can reliably control pests, and a molded article using the same.

### MODES FOR CARRYING OUT THE INVENTION

In this specification, the unit “mass %” for content synonymous with “g/100 g”.

### [Resin Composition]

The resin composition of the present invention contains fipronil, an insect growth regulator, a plasticizer, a fatty acid, and a vinyl chloride resin.

### (Fipronil)

Fipronil means 5-amino-1-[2,6-dichloro-4-(trifluoromethyl)phenyl]-4-(trifluoromethylsulfonyl)-1H-pyrazole-3-carbonitrile. Any active stereoisomer or mixture can be used as fipronil.

In the resin composition of the present invention, from the viewpoint of exhibiting the effects of the present invention, the content of fipronil with respect to the total amount of the resin composition is preferably 0.5 mass % or more and 40 mass % or less, more preferably 1 mass % or more and 25 mass or less, and even more preferably 3 mass % or more and 20 mass % or less.

### (Plasticizer)

In the present invention, the plasticizer that can be used for the vinyl chloride resin is one or more selected from the group consisting of phosphoric esters, diisononyl adipate, diisodecyl adipate, di-2-ethylhexyl azelate, sebacic acid, 2-ethylhexyl and diethylene glycol monoethyl ether. As the plasticizer, one or a combination of two or more selected from the group consisting of diisononyl adipate, phosphoric esters and diethylene glycol monoethyl ether is preferable.

Examples of phosphoric esters include trixylenyl phosphate, cresyl diphenyl phosphate, 2-ethylhexyl diphenyl phosphate, aromatic condensed phosphoric ester, tricresyl phosphate, triethyl phosphate, tributyl phosphate, tri-2-ethylhexyl phosphate, or combinations thereof. Among these, triethyl phosphate, tri-2-ethylhexyl phosphate, or tributyl phosphate is preferred, triethyl phosphate or tributyl phosphate is more preferred, and tributyl phosphate is even more preferred. Phosphoric esters can be used individually or in combination of two or more.

In the resin composition of the present invention, from the viewpoint of exhibiting the effects of the present invention, the content of the plasticizer with respect to the total amount of the resin composition is preferably 5 mass or more and 50 mass % or less, and more preferably 10 mass or more and 40 mass % or less.

In the resin composition of the present invention, from the viewpoint of exhibiting the effects of the present invention, the content of phosphoric ester with respect to the total amount of the resin composition is preferably 1 mass % or more and 20 mass % or less, more preferably 1.8 mass % or more and 15 mass % or less, and even more preferably 2.2 mass % or more and 12 mass % or less.

In the resin composition of the present invention, from the viewpoint of exhibiting the effects of the present invention, the content of triethyl phosphate with respect to the total amount of the resin composition is preferably 1 mass or more and 20 mass % or less, more preferably 1.8 mass % or more and 15 mass % or less, and even more preferably 2.2 mass % or more and 12 mass % or less.

### (Fatty Acid)

Fatty acids can be used as a bleed promoter in the present invention. Examples of such fatty acids include lauric acid, myristic acid, palmitic acid, stearic acid, isostearic acid, linoleic acid, oleic acid, arachidic acid, and behenic acid. Among these, lauric acid, myristic acid, palmitic acid, stearic acid, isostearic acid, linoleic acid, or oleic acid is preferred, stearic acid, isostearic acid, linoleic acid, or oleic acid is more preferred, and isostearic acid is even more preferred. Fatty acids can be used individually or in combination of two or more.

In the resin composition of the present invention, from the viewpoint of exhibiting the effects of the present invention, the content of fatty acid with respect to the total amount of the resin composition is preferably 0.01 mass % or more and 15 mass % or less, more preferably 0.2 mass % or more and 8.0 mass % or less, and even more preferably 0.7 mass % or more and 4.0 mass % or less.

In the resin composition of the present invention, from the viewpoint of exhibiting the effects of the present invention, the content of isostearic acid with respect to the total amount of the resin composition is preferably 0.01 mass % or more and 15 mass % or less, more preferably 0.2 mass % or more and 8.0 mass % or less, and even more preferably 0.7 mass % or more and 4.0 mass % or less.

### (Insect Growth Regulator)

An insect growth regulator refers to a substance that inhibits insect molting and eclosion by controlling the balance of hormones that regulate insect metamorphosis and molting. Insect growth regulators include chitin synthesis inhibitors represented by benzoylurea compounds such as chlorfluazuron, diflubenzuron, flufenoxuron, lufenuron, novaluron, and teflubenzuron; molting hormone active compounds such as ecdysteroids; and one or more juvenile hormone-like substances selected from the group consisting of hydroprene, kinoprene, fenoxycarb, pyriproxyfen, diofenolan, epofenonane, triprene, methoprene (particularly S-methoprene), and hydroprene. These insect growth regulators can be used individually or in combination of two or more. Any active stereoisomer or mixture thereof can be used as these compounds. Among these, juvenile hormone-like substances or chitin synthesis inhibitors are preferred, juvenile hormone-like substances are more preferred, and at least one selected from the group consisting of pyriproxyfen and S-methoprene is even more preferred.

In the resin composition of the present invention, from the viewpoint of exhibiting the effects of the present invention, the content of the insect growth regulator with respect to the total amount of the resin composition is preferably 0.01 mass % or more and 10 mass % or less, more preferably 0.1 mass % or more and 7 mass % or less, and even more preferably 0.2 mass % or more and 5 mass % or less.

Particularly, in the resin composition of the present invention, from the viewpoint of exhibiting the effects of the present invention, the total content of pyriproxyfen and S-methoprene with respect to the total amount of the resin composition is preferably 0.01 mass % or more and 10 mass % or less, more preferably 0.1 mass % or more and 7 mass % or less, and even more preferably 0.2 mass % or more and 5 mass % or less.

In the resin composition of the present invention, the ratio of the insect growth regulator to fipronil is preferably 0.00025 parts by mass or more and 1 part by mass or less, more preferably 0.0045 parts by mass or more and 0.65 parts by mass or less, and even more preferably 0.01 parts by mass or more and 0.45 parts by mass or less, per 1 part by mass of fipronil.

In the resin composition of the present invention, the ratio of the total amount of pyriproxyfen and S-methoprene to fipronil is preferably 0.00025 parts by mass or more and 1 part by mass or less, more preferably 0.0045 parts by mass or more and 0.65 parts by mass or less, and even more preferably 0.01 parts by mass or more and 0.45 parts by mass or less, per 1 part by mass of fipronil.

### (Vinyl Chloride Resin)

The resin serving as the base material for the resin composition of the present invention is a vinyl chloride resin, which is a polymer having a group represented by —CH2-CHCl—. Such vinyl chloride resins include homopolymers of vinyl chloride monomers, as well as copolymers of vinyl chloride monomers with other copolymerizable monomers. Furthermore, chlorinated vinyl chloride resins may also be used.

Examples of other monomers copolymerizable with vinyl chloride monomers include α-olefins; vinyl esters; vinyl ethers; (meth)acrylic acid esters; aromatic vinyls; N-substituted maleimides; and the like. These other monomers may also be used in combination.

The resin serving as the base material for the resin composition of the present invention is preferably a vinyl chloride resin composed of a homopolymer. For example, two or more types of vinyl chloride monomers that are homopolymers with different degrees of polymerization can be used.

From the viewpoint of achieving both moldability and bleed, the average degree of polymerization of the vinyl chloride resin of the present invention preferably includes, at least in part, a homopolymer with a degree of polymerization of 1000 to 1600, and more preferably includes a homopolymer with a degree of polymerization of 1350 to 1500. Here, the average degree of polymerization is measured according to JIS K-6721 “Test Methods for Vinyl Chloride Resins,” using as a sample the resin obtained by dissolving polyvinyl chloride resin in tetrahydrofuran (THF), removing insoluble components by filtration, and then drying and removing THE from the filtrate.

As the vinyl chloride resin of the present invention, commercially available products can be used. For example, “ZEST 1400Z” (product name) polyvinyl chloride (average degree of polymerization 1450) from Shinetsu Chemical Co., Ltd. and “TK-1400” (product name) polyvinyl chloride (average degree of polymerization 1400) from Shinetsu Chemical Co., Ltd. can be used.

Furthermore, in addition to such resins, it is also possible to use vinyl chloride resins composed of homopolymers with different properties in combination. Different properties refer to cases where the average degree of polymerization or particle size differs. For example, it is also preferable to mix fine powder polyvinyl chloride resin (particle size is about 100 μm or less).

Typical examples of use include a combination of “ZEST 1400Z” (average degree of polymerization 1450) and “ZEST P24Z” (average degree of polymerization 1200 to 1390) polyvinyl chloride from Shinetsu Chemical Co., Ltd., but are not limited thereto.

Particularly, in the resin composition of the present invention, from the viewpoint of exhibiting the effects of the present invention, the content of vinyl chloride resin with respect to the total amount of the resin composition is preferably 40 mass % or more and 65 mass % or less, more preferably 42 mass % or more and 60 mass % or less, and even more preferably 45 mass % or more and 55 mass % or less.

In the resin composition of the present invention, when two or more types of vinyl chloride resins with different degrees of polymerization are contained, for example, the ratio of vinyl chloride resin with an average degree of polymerization of 1200 to 1390 to 1 part by mass of vinyl chloride resin with an average degree of polymerization of 1400 to 1500 is preferably 0.005 parts by mass or more and 0.8 parts by mass or less, more preferably 0.03 parts by mass or more and 0.5 parts by mass or less, and even more preferably 0.05 parts by mass or more and 0.2 parts by mass or less. For example, the ratio of ZEST P24Z to ZEST 1400Z is preferably 0.005 parts by mass or more and 0.8 parts by mass or less, more preferably 0.03 parts by mass or more and 0.5 parts by mass or less, and even more preferably 0.05 parts by mass or more and 0.2 parts by mass or less, per 1 part by mass of ZEST 1400Z.

### (Pests)

Pests as referred to in this specification include, but are not limited to, parasitic or blood-sucking pests such as fleas (including fleas parasitic on dogs, cats, etc.), ticks (including hard ticks, chiggers, oribatid mites, scab mites, and Cheyletiella mites), or lice, and mosquitoes.

Particularly preferred target pests for control are fleas, ticks, mosquitoes, or lice.

The animals of the present invention include various animals such as various pets, livestock, and poultry. In particular, pets such as dogs, cats, rabbits, or hamsters, and livestock or poultry such as cattle, horses, pigs, or chickens are mentioned. Among these, the animal is preferably a dog, cat, rabbit, or hamster, more preferably a dog, cat, or rabbit, and even more preferably a dog or cat.

### (Other Components)

As long as the effects of the present invention are not inhibited, the resin composition of the present invention may contain any components other than fipronil, insect growth regulators, plasticizers, and fatty acids in the vinyl chloride resin. For example, optional components include other pest control ingredients besides fipronil and insect growth regulators, stabilizers, pigments, fragrances, and the like.

Examples of stabilizers that can be used in the present invention include one or more selected from the group consisting of epoxidized soybean oil, barium/zinc liquid stabilizers, and barium stearate. It is also desirable to use all of these in combination. The amount of stabilizer is not limited, but is preferably 0.5 to 10 mass, more preferably 1 to 8 mass %, and even more preferably 2 to 6 mass %.

### (Method for Producing Resin Composition and Molded Article)

The resin composition of the present invention can be produced by, for example, but not limited to, the following method. First, a vinyl chloride resin and a pigment are mixed, and separately, other raw materials are mixed, and then these are mixed to prepare a mixture. Alternatively, fipronil, a vinyl chloride resin, and a pigment are mixed, and separately, other raw material components are mixed, and then these are mixed to prepare a mixture. At this time, fipronil can be mixed in a solid state. The mixing temperature can be in the range of 1 to 30° C., and the mixing time can be about 1 to 20 minutes. After mixing, it is dried at a high temperature.

The temperature at this time is not limited, but is preferably about 100° C. or more and 150° C. or less. Mixing and heat drying are repeated until the resin is dried up. At this time, for example, a banbury mixer, a super mixer, or the like can also be used.

Next, the resin composition thus obtained is formed into a molded article for pest control. At this time, for example, it can also be molded by melting. As a method for producing a molded article, methods generally used for resin molding can be used. Such methods include, for example, extrusion molding, injection molding, blow molding, compression molding, powder molding, or press molding. Although not limited, it is preferable to produce the molded article using an injection molding machine.

### Applications, Etc.

The resin composition of the present invention can be used as, but not limited to, collars, ear tags, tail tags, limb bands, or halters. Among these, it can be particularly preferably used as a pest control collar.

The resin composition of the present invention can be molded into films, sheets, fibers, nets, by rings, etc., appropriately selecting the shape, size, thickness, etc., depending on the application. For the purpose of use as a pest control collar, it can first be molded into a band or strip shape, but it is also possible to melt the resin with an injection molding machine or the like and directly mold it into a shape according to the application. For example, it can be poured into a collar-shaped mold and cooled to be directly molded into a collar.

As an example, but not limited to, a collar of a specific size can be molded using an injection molding machine at a temperature setting of 138 to 145° C., an injection time of 2 to 3 seconds, and a cooling time of 8 to 15 seconds. Typically, for example, it can be molded into a collar shape with a length of 30 cm to 80 cm, a width of 0.5 cm to 1.5 cm, and a thickness of 0.1 to 0.5 cm.

### (Resin Molded Article)

The resin molded article obtained from the resin composition of the present invention can be used by replacing it once every 6 months or once a year, depending on the application. In particular, it can be used at these frequencies as a collar for medium-sized or large dogs.

The molded article obtained from the resin composition of the present invention preferably has a good balance of elongation and strength when measured by a method conforming to the measurement method described in the working examples. Such a balance can be achieved, for example, when the value of the elongation rate (%)/strength (N) of the resin molded article is approximately 0.5 or more and 1.5 or less. That is, it is a molded article that has sufficient elongation while maintaining strength, and although not limited, it can be judged to be suitable for collar applications.

### [Method for Improving Strength, Etc.]

The present invention also relates to a method for improving the strength of a resin molded article obtained from a resin composition by preparing a resin composition in which a vinyl chloride resin, fipronil, an insect growth regulator, a plasticizer, and a fatty acid coexist. In the method for improving strength of the present invention, fipronil, the insect growth regulator, the plasticizer, and the fatty acid and their contents are as described for the resin composition. Furthermore, the present invention also relates to a method for imparting appropriate elongation to a resin molded article.

Some aspects of the present invention are as follows: [1] A pest control resin composition comprising a vinyl chloride resin, fipronil, an insect growth regulator, a plasticizer, and a fatty acid. [2] The pest control resin composition according to [1], wherein the plasticizer is one or more selected from the group consisting of phosphoric esters, diisononyl adipate, diisodecyl adipate, di-2-ethylhexyl azelate, sebacic acid, 2-ethylhexyl, and diethylene glycol monoethyl ether. [3] The pest control resin composition according to [1] or [2], wherein the fatty acid is isostearic acid. [4] The pest control resin composition according to any one of [1] to [3], wherein the content of fipronil is 0.5 mass % or more and 40 mass % or less of the total composition. [5] The pest control resin composition according to any one of [1] to [4], wherein the content of the plasticizer is 5 mass % or more and 50 mass % or less of the total composition. [6] The pest control resin composition according to any one of [1] to [5], wherein the content of the fatty acid is 0.01 mass % or more and 15 mass % or less of the total composition. [7] The pest control resin composition according to any one of [1] to [6], wherein the insect growth regulator is a juvenile hormone-like substance. [8] The pest control resin composition according to [7], wherein the insect growth regulator is at least one selected from the group consisting of pyriproxyfen and S-methoprene. [9] The pest control resin composition according to any one of [1] to [8], wherein the ratio of the insect growth regulator to 1 part by mass of fipronil is 0.00025 parts by mass or more and 1 part by mass. [10] The pest control resin composition according to any one of [1] to [9], wherein the vinyl chloride resin includes at least a homopolymer with an

average degree of polymerization of 1000 to 1600. [11] The pest control resin composition according to any one of [1] to [10], wherein the content of the vinyl chloride resin is 40 mass % or more and 65 mass % or less of the total composition. [12] The pest control resin composition according to any one of [1] to [11], wherein vinyl chloride resins with different average degrees of polymerization are used in combination as the vinyl chloride resin. [13] The pest control resin composition according to any one of [1] to [12], further containing one or more selected from the group consisting of epoxidized soybean oil, a barium/zinc liquid stabilizer, and barium stearate as a stabilizer.

Furthermore, in another aspect of the present invention, the following molded article is provided: [14] A sustained-release pest control resin molded article formed by molding the pest control resin composition according to any one of claims 1 to 13. [15] The sustained-release pest control resin molded article according to [14], wherein the sustained-release pest control resin molded article is a collar. A method for improving the strength of a resin molded article obtained from a resin composition by coexisting a vinyl chloride resin, fipronil, an insect growth regulator, a plasticizer, and a fatty acid in the composition.

### EXAMPLES

Next, the present invention will be specifically described by way of examples, but the present invention is not limited to the following examples. In the tables, the unit for each component amount is mass % unless otherwise specified in the table.

Collars made of the resin composition of the examples were produced by the following method. The raw material components other than the vinyl chloride resin and pigment shown in Table 1 were mixed at room temperature for about 10 minutes to prepare a mixture.

Thereafter, the vinyl chloride resin, pigment, and the mixture of raw material components were stirred and dried at a high temperature. The temperature at this time was 120° C. Stirring and heat drying were repeated until the resin dried up.

Next, the resin composition thus obtained was used to produce a collar molded article using an injection molding machine (SE180D). Using the injection molding machine, at a temperature setting of 138 to 145° C., with an injection time of 2 to 3 seconds and a cooling time of 8 to 15 seconds, the resin was poured into a collar-shaped mold with a length of 35 cm, a width of 1.0 cm, and a thickness of 0.3 cm, and cooled to be directly molded into a collar.

Tensile Strength Measurement Test [2] The obtained collar was cut to 13 cm, and for that section, jigs were set at two locations with a 50 mm interval, and elongation rate and strength were measured at a speed of 50 mm/min using AUTOGRAPH AG-X 50N (manufactured by Shimadzu Corporation).

The results are also shown in Table 1.

TABLE 1

| | prescription (mass %) | | | | | | |
|---|---|---|---|---|---|---|---|
| | Example 1 | Example 2 | Example 3 | Example | Example | Example | reference |
| materials | Fipronil \textcircled{1} | Fipronil \textcircled{2} | Fipronil \textcircled{3} | Fipronil \textcircled{4} | Fipronil \textcircled{5} | Fipronil \textcircled{6} | Phenothrin |
| Fipronil | 5 | 10 | 5 | 10 | 10 | 10 | 0 |
| Phenothrin | 0 | 0 | 0 | 0 | 0 | 0 | 12 |
| Pyriproxyfen | 2 | 2 | 0 | 2 | 2 | 2 | 2 |
| S-Methoprene | 0 | 0 | 2 | 0 | 0 | 0 | 0 |
| Diisodecyl adipate | 27.3 | 22.3 | 27.3 | 0 | 0 | 10 | 24.8 |
| Triethyl phosphate | 8.6 | 8.6 | 8.6 | 8.6 | 0 | 0 | 8.6 |
| Diethylene glycol | 0 | 0 | 0 | 22.3 | 22.3 | 12.3 | 0 |
| monoethyl ether | | | | | | | |
| O-130P (epoxidized | 2.3 | 2.3 | 2.3 | 2.3 | 2.3 | 2.3 | 2.3 |
| soybean oil) | | | | | | | |
| LBZ (barium/ | 1.1 | 1.1 | 1.1 | 1.1 | 1.1 | 1.1 | 1.1 |
| zincliquid | | | | | | | |
| stabilizer) | | | | | | | |
| Isostearic acid | 2.7 | 2.7 | 2.7 | 2.7 | 2.7 | 2.7 | 2.7 |
| Barium stearate | 0.2 | 0.2 | 0.2 | 0.2 | 0.2 | 0.2 | 0.2 |
| Vinyl | 47.7 | 47.7 | 47.7 | 47.7 | 56.3 | 56.3 | 43.2 |
| chloride (1400) | | | | | | | |
| Vinyl chloride | 2.7 | 2.7 | 2.7 | 2.7 | 2.7 | 2.7 | 2.7 |
| pigment | 0.4 | 0.4 | 0.4 | 0.4 | 0.4 | 0.4 | 0.4 |
| Total | 100 | 100 | 100 | 100 | 100 | 100 | 100 |
| Elongation rate | 184 | 201 | 203 | 210 | 190 | 220 | 219 |
| rate (%) | | | | | | | |
| Strength (N) | 175 | 177 | 186 | 185 | 183 | 185 | 135 |
| elongation rate/ | 1.05 | 1.14 | 1.09 | 1.14 | 1.04 | 1.19 | 1.62 |
| Strength | | | | | | | |

As a result of the test, it was shown that the molded articles obtained from the compositions of the examples all had excellent strength, which was enhanced while having an elongation rate comparable to that of molded articles containing phenothrin.

That is, it was found that the molded articles obtained from the compositions of the examples had an elongation rate (%)/strength (N) value of 0.5 or more and 1.5 or less, indicating that they were molded articles with sufficient elongation while maintaining strength.

1. A pest control resin composition comprising a vinyl chloride resin, fipronil, an insect growth regulator, a plasticizer, and a fatty acid.

2. The pest control resin composition according to claim 1, wherein the plasticizer is one or more selected from the group consisting of phosphoric esters, diisononyl adipate, diisodecyl adipate, di-2-ethylhexyl azelate, sebacic acid, 2-ethylhexyl, and diethylene glycol monoethyl ether.

3. The pest control resin composition according to claim 1, wherein the fatty acid is isostearic acid.

4. The pest control resin composition according to claim 1, wherein the content of fipronil is 0.5 mass % or more and 40 mass % or less of the total composition.

5. The pest control resin composition according to claim 1, wherein the content of the plasticizer is 5 mass % or more and 50 mass % or less of the total composition.

6. The pest control resin composition according to claim 1, wherein the content of the fatty acid is 0.01 mass % or more and 15 mass % or less of the total composition.

7. The pest control resin composition according to claim 1, wherein the insect growth regulator is at least one selected from the group consisting of pyriproxyfen and S-methoprene.

8. A sustained-release pest control resin molded article formed by molding the pest control resin composition according to claim 1.

9. The sustained-release pest control resin molded article according to claim 8, wherein the sustained-release pest control resin molded article is a collar.

10. A method for improving the strength of a resin molded article obtained from a composition by coexisting a vinyl chloride resin, fipronil, an insect growth regulator, a plasticizer, and a fatty acid in the composition.
